(19) United States
(12) Patent Application Publication
(10) Pub. No.: US 2022/0229254 A1
(43) Pub. Date: Jul. 21, 2022

(54) BLADED PANEL SYSTEM AND COMPONENTS THEREFORE

(71) Applicant: COMMSCOPE TECHNOLOGIES LLC, Hickory, NC (US)

(72) Inventors: Scott C. SIEVERS, Jordan, MN (US); Jill Anne MALECHA, New Prague, MN (US); Michael J. WENTWORTH, Belle Plaine, MN (US); John T. PFARR, Le Sueur, MN (US); Loren J. MATTSON, Richfield, MN (US); Rodney C. SCHOENFELDER, Shakopee, MN (US)

(73) Assignee: COMMSCOPE TECHNOLOGIES LLC, Hickory, NC (US)

(21) Appl. No.: 17/622,949

(22) PCT Filed: Jun. 26, 2020
(86) PCT No.: PCT/US2020/039881

§ 371 Date: Dec. 27, 2021

Related U.S. Application Data
(60) Provisional application No. 62/868,468, filed on Jun. 28, 2019.

(51) Int. Cl. G02B 6/44; G02B 6/38

(52) U.S. Cl. CPC G02B 6/4452; G02B 6/4292; G02B 6/3897; G02B 6/3825

(57) ABSTRACT

A blade for use within a chassis panel includes alternating types of mounting stations at which port modules can be received. Various example port modules include single-fiber adapter packs, multi-fiber adapter packs, adapter modules defining rear ports, and optical cassettes defining rear non-port entrances.

### CROSS-REFERENCE TO RELATED APPLICATION

This application is being filed on Jun. 26, 2020 as a PCT International Patent Application and claims the benefit of U.S. Patent Application Ser. No. 62/868,468, filed on Jun. 28, 2019, the disclosure of which is incorporated herein by reference in its entirety.

### BACKGROUND

Chassis panel systems can hold a plurality of ports at which connections can be made. For example, one or more optical adapters can be mounted within a chassis. Of course, electrical jacks or other port modules also can be mounted within the chassis. In some cases, the port modules can be mounted to movable (e.g., slidable) trays or blades within the chassis. Cables connected to rear-facing ports of the port modules extend towards the rear of the chassis. A cable management module is typically disposed at the rear of the chassis to manage the cables during movement of the trays or blades.

Improvements are desired.

### SUMMARY

Aspects of the disclosure are directed to a bladed chassis panel, a blade therefore, and components for inclusion thereon.

In accordance with certain aspects of the disclosure, the blade includes multiple mounting stations at which port modules can be loaded onto the blade. For example, a port module may include oppositely facing mounting structure received at adjacent mounting stations.

In certain implementations, the blade may include different types of mounting stations. For example, a first type of mounting station may include a latch deflectable along a first axis and a second type of mounting station may include a latch deflectable along a second axis that is oriented differently from the first axis. In an example, the first and second axes are transverse to each other. In certain examples, the mounting station types alternate along a row across a width of the blade.

In accordance with certain aspects of the disclosure, various types of port modules may be installed on the blade at the mounting stations. In certain implementations, each of the port modules has a common mounting structure so that any desired combination of port modules can be installed at the blade

In some implementations, the port modules defines a common number of front and rear ports. In some examples, the ports are single-fiber ports. In other examples, the ports are multi-fiber ports. In other implementations, the port module defines fewer rear ports than front ports. In still other implementations, the port module defines a rear, non-port entrance and multiple front ports.

In certain implementations, the port modules include a protection body coupled to an adapter pack. The protection body defines the rear port(s) and/or rear non-port entrance. An optical circuit is disposed within the protection body. The optical circuit optically couples the rear port(s) or entrance to the front ports. In certain implementations, the optical circuit includes one or more optical splices. The protection body provides routing paths that inhibit over bending of the optical fibers. In certain examples, the routing paths may be multi-level.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front perspective view of an example chassis panel including a chassis body, a cable management arrangement, and a removable rear cover configured in accordance with the principles of the present disclosure;

FIG. 2 is a perspective view of an example blade suitable for use with the chassis panel of FIG. 1, the blade being configured to hold any combination of multiple types of port modules;

FIG. 3 is a cross-sectional view of a portion of the blade of FIG. 2 showing a first type of mounting station;

FIG. 4 is a perspective view of a portion of the blade of FIG. 2 showing a second type of mounting station;

FIG. 5 is a side elevational view of the second type of mounting station of FIG. 4;

FIG. 6 is a perspective view of a first example port module suitable for use with the blade of FIG. 2, the first example port module including of a multi-fiber adapter pack;

FIG. 7 is an exploded view of the multi-fiber adapter pack of FIG. 6;

FIG. 8 is a cross-sectional view of the adapter pack of FIG. 6 taken through the separator walls between adapters;

FIG. 9 is a perspective view of a second example port module suitable for use with the blade of FIG. 2, the second example port module including of a single-fiber adapter pack;

FIG. 10 is an exploded view of the single-fiber adapter pack of FIG. 9;

FIG. 11 is a top perspective view of a third example port module suitable for use with the blade of FIG. 2, the third example port module including an adapter module having multiple front ports and a rear port;

FIG. 12 is a bottom perspective view of the adapter module of FIG. 11;

FIG. 13 is an exploded view of the adapter module of FIG. 11;

FIG. 14 is a perspective view of a fourth example port module suitable for use with the blade of FIG. 2, the fourth example port module including an optical cassette having multiple front ports and a rear non-port entrance;

FIG. 15 is a perspective view of a base of a protective body of the cassette of FIG. 14;

FIG. 16 is a partially exploded view of the optical cassette of FIG. 11 with the adapter pack cover exploded from the port body, which is attached to a protective body from which a corresponding cover has been removed;

FIG. 17 is a top plan view of an example base of the cassette of FIG. 16 with representative fibers shown routed therethrough;

FIG. 18 is a perspective view of the optical cassette of FIG. 14 with the protective cover removed and a single-fiber splice chip loaded therein;

FIG. 19 is an exploded view of the optical cassette of FIG. 18;

FIG. 20 is a perspective view of the optical cassette of FIG. 14 with the protective cover removed and a splice reel loaded therein;

FIG. 21 is an exploded view of the optical cassette of FIG. 20;

FIG. 22 is a top perspective view of the splice reel of FIG. 20;

FIG. 23 is a bottom perspective view of the splice reel of FIG. 20;

FIG. 24 is a top perspective view of the optical cassette of FIG. 20 with a channel extender;

FIG. 25 is a perspective view of a portion of the blade of FIG. 2 showing an alternative second type of mounting station; and

FIG. 26 is a perspective view of an example blade suitable for use with the chassis panel of FIG. 1, the blade being configured to hold any combination of multiple types of port modules, the blade also including a rear handle.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

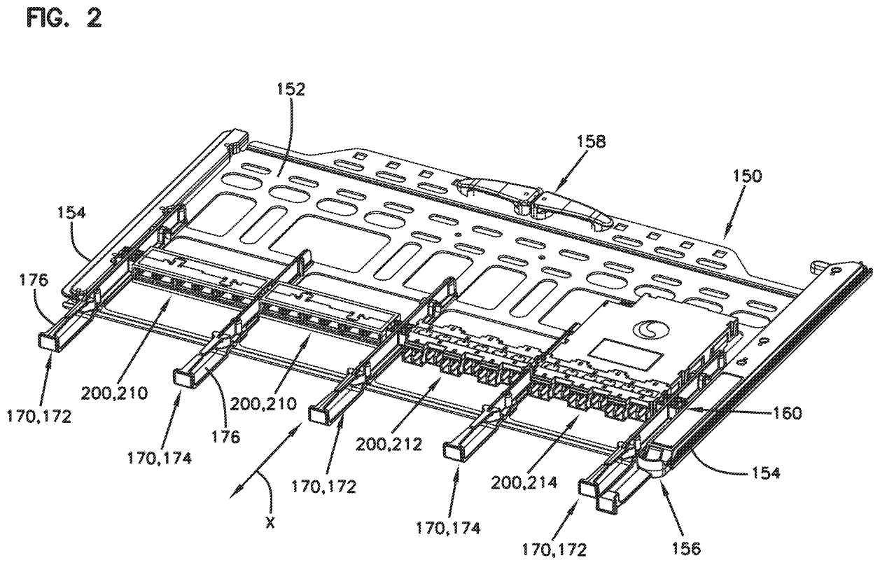

The present disclosure is directed to a chassis panel 100 including a chassis body 110 that receives one or more blades 150 within the interior. Each blade 150 is movable relative to the chassis body 110 along a forward-rearward axis between at least a retracted position and a forwardly extended position. Each blade 150 carries one or more port modules 200 along the forward-rearward axis X (FIG. 2). Each port module 200 includes at least one front port configured to receive a plug connector and at least one rear port configured to receive a plug connector.

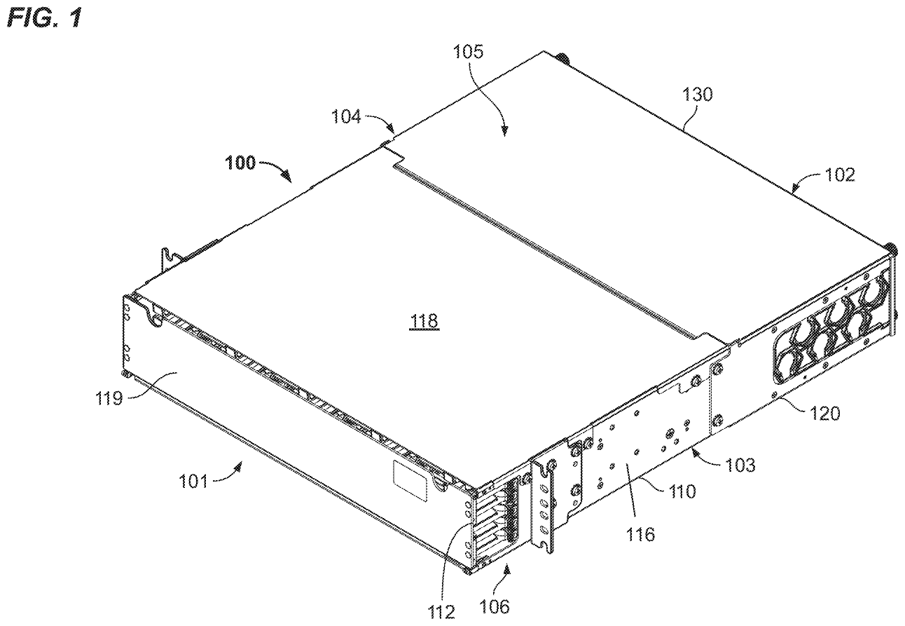

Referring to FIG. 1, the chassis panel 100 extends along a depth between a front 101 and a rear 102, along a width between opposite first and second sides 103, 104, and along a height between a top 105 and a bottom 106. The chassis body 110 defines an open front 112 at the front 101 of the chassis panel 100. The chassis body 110 also defines an open rear. The forward-rearward axis extends between the open front and the open rear.

A cover 119 may be mounted at the open front 112 of the chassis body 110 to selectively cover the open front 112. The cover 119 may be movable between a closed position and an open position. The cover 119 inhibits access to an interior of the chassis body 110 through the open front 112 when the cover 119 is disposed in the closed position. The cover 119 allows access to an interior of the chassis body 110 through the open front 112 when the cover 119 is disposed in the open position.

In certain implementations, a cable management arrangement 120 is mounted to the chassis body 110 at the open rear. In certain examples, a rear cover 130 mounts to the cable management arrangement 120 to inhibit access to the open rear of the chassis body 110.

Opposite sidewalls 116 extend between the open front 112 and the open rear of the chassis body 110. Opposite end walls 118 extend between the open front 112 and the open rear and between the opposite sidewalls 116 of the chassis body 110. In certain implementations, the chassis body 110 is configured to mount to a rack frame. For example, brackets may be attached to the chassis body 110.

Example chassis bodies 110 and front covers 119 suitable for use with the chassis panel 100 described herein are disclosed in U.S. Pat. Nos. 8,934,252; 9,709,765; and U.S. Publication No. 2018/0224621, the disclosures of which are hereby incorporated herein by reference in their entirety. Example cable management arrangements 120 and rear covers 130 suitable for use with the chassis panel 100 described herein are disclosed in co-pending U.S. Provisional Application No. 62/852,571, filed May 24, 2019, titled “Chassis Panel with Selectable Cable Management Insert and Cabling Method Therefore,” the disclosure of which is hereby incorporated herein by reference.

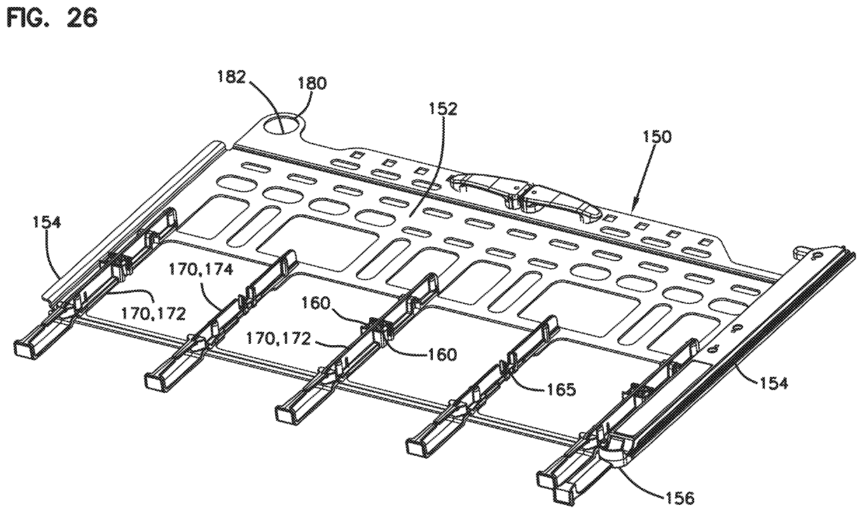

Referring to FIG. 2, an example blade 150 includes a body 152 extending between rails 154. In some implementations, one or both rails 154 are integral with the blade body 152 (see FIG. 26). In other implementations, both rails 154 are coupled to the blade body 152 (see FIG. 2). Each blade 150 is slidable relative to the chassis body 110 along the forward-rearward axis. In certain implementations, the rails 154 slide along guide members supported by the sidewalls 116 of the chassis body 110.

Each blade 150 includes a releasable locking arrangement 156 by which the blade 150 is releasably held in one or more discrete positions along the forward-rearward axis X. In certain implementations, a blade 150 includes a handle 180 by which the blade body 152 can be moved along the forward-rearward axis X. In certain examples, the handle 180 is disposed at a rear of the blade body 152. In the depicted example, the handle 180 is disposed at a rear corner of the blade body 152. In certain examples, the handle 180 defines an aperture 182 to accommodate a finger of a user to pull the blade 150 by the handle 180. Each blade 150 also may include cable management 158 at a rear of the blade body 152. Example locking arrangements 156 and cable management 158 suitable for use with the blades 150 described herein are disclosed in U.S. Pat. Nos. 8,934,252; 9,709,765; and U.S. Publication No. 2018/0224621, the disclosures of which incorporated by reference above.

In certain implementations, one or more port modules 200 are mounted to each blade 150 to be carried with the respective blade 150. In certain implementations, each port module 200 defines a plurality of front ports. In some implementations, each port module 200 defines a plurality of rear ports aligned with respective ones of the front ports. In other implementations, each port module 200 defines a single rear port. In some examples, the front ports of a port module 200 are laterally aligned along a plane transverse to the forward-rearward axis. In other examples, the front ports of a port module 200 are offset from each other along the forward-rearward axis X.

In certain implementations, the blade 150 defines a plurality of mounting stations 160, 165 at which mounting structures 205 of the port modules 200 are secured. In certain examples, the mounting stations 160, 165 are disposed in a row extending across a width of the blade 150 transverse to the forward-rearward axis X. Accordingly, multiple port modules 200 can be mounted in a row across the width of the blade 150. In certain implementations, multiple types of port modules 200 have a common mounting structure 205, as will be disclosed in more detail herein, so that the configuration of port modules 200 can be customized for each blade 150.

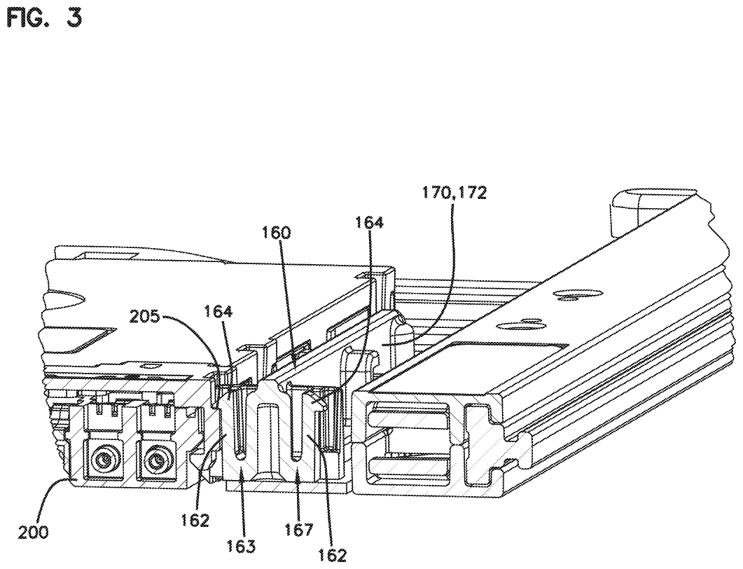

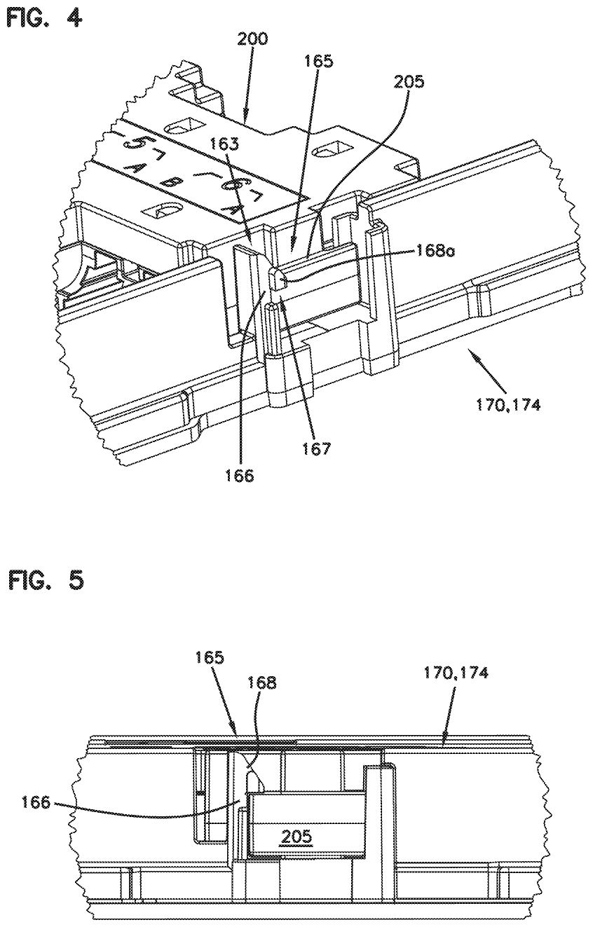

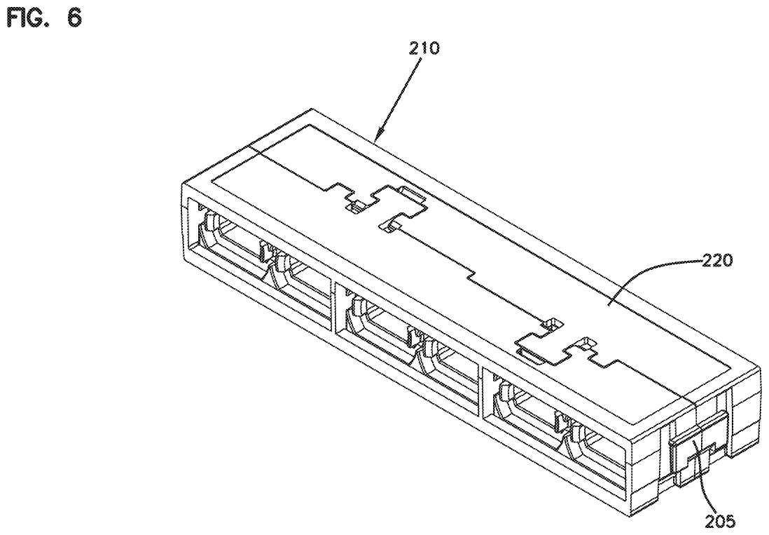

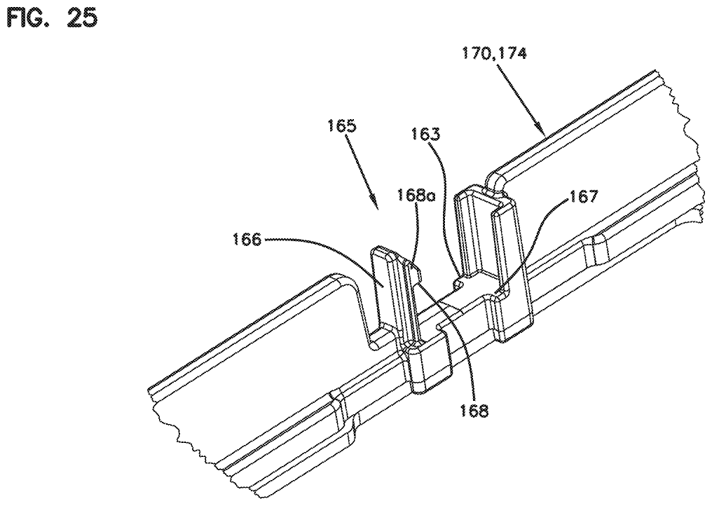

In some implementations, the port modules 200 are latched to the mounting stations. For example, each of the mounting stations 160, 165 may include a latching arrangement including one or more latching fingers 162, 166 that flex to receive the mounting structure 205 of the port module 200. Each latching finger 162, 166 defines a catch 164, 168 at the distal end. In some examples, the latching finger 162 of a first mounting station 160 is configured to flex transverse to the forward-rearward axis X (e.g., see FIG. 3). In other examples, the latching finger 166 of a second example mounting station 165 is configured to flex parallel to the forward-rearward axis X (e.g., see FIGS. 4, 5, and 25). In other implementations, the port modules 200 may be otherwise secured to the mounting stations 160, 165.

In certain implementations, each port module 200 includes mounting structure 205 at a first end and mounting structure 205 at an opposite second end. The mounting structure 205 at the first end secures to a mounting station 160, 165 and the mounting structure 205 at the second end secures to an adjacent mounting station 160, 165. The port module 200 extends between the two mounting stations.

In certain implementations, a blade 150 can include multiple types of mounting stations 160, 165. For example, a first type of mounting station 160 may include one or more latch fingers 162 that flex transverse to the forward-rearward axis X and a second type of mounting station 165 may include one or more latch fingers 166 that flex parallel to the forward-rearward axis X. In certain examples, the first type of mounting station 160 includes two independently deflectable latch fingers 162 that face in opposite directions. In certain examples, the second type of mounting station 165 includes a single deflectable latch finger 166. In an example, the catch 168 of the single latch finger 166 has protrusion 168A extending laterally in opposite directions.

In certain implementations, the blade 150 includes an alternating sequence of types of mounting stations 160, 165 across the width of the blade 150. For example, the blade 150 may include mounting stations 160 of the first type at opposite sides of the blade 150 and at a center of the blade 150. The blade 150 also may include one mounting station 165 of the second type between a first outermost station 160 and the center station 160 and another mounting station 165 of the second type between the center station 160 and the other outermost station 160.

In certain implementations, each mounting station 160, 165 is configured to secure mounting structures 205 of two port modules 200. For example, each mounting station 160, 165 defines a first receiving section 163 and a second receiving section 167. Each receiving section 163, 167 is sized and shaped so that the mounting structure 205 fits thereat. In certain examples, each receiving section 163, 167 defines a separate channel into which the mounting structure 205 is inserted. In some examples, the one or more latch fingers 162, 166 flex within the channels. In other examples, the one or more latch fingers 166 flex between the channels.

In certain implementations, the mounting stations 160, 165 are defined by mounting members 170 connected to the blade body 152 (e.g., see FIG. 2). The mounting members 170 are elongate along the forward-rearward axis X. Each mounting member 170 defines one of the mounting stations 160, 165. In certain implementations, a first type 172 of mounting member 170 defines the first type of mounting station 160 and a second type 174 of mounting member 174 defines the second type of mounting station 165. In certain implementations, forward ends of the mounting members 170 define routing guides 176 to guide fibers or cables to the front ports of the port modules 170 loaded on the blade 150. In certain examples, the different types of mounting members 170 have a common length.

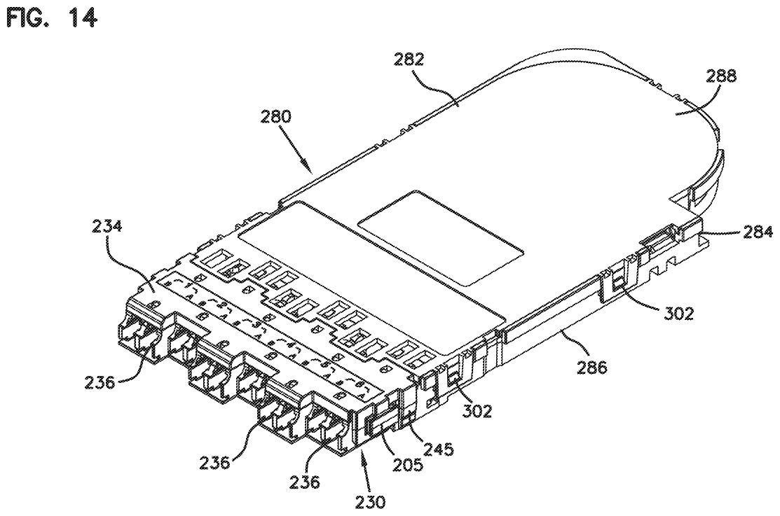

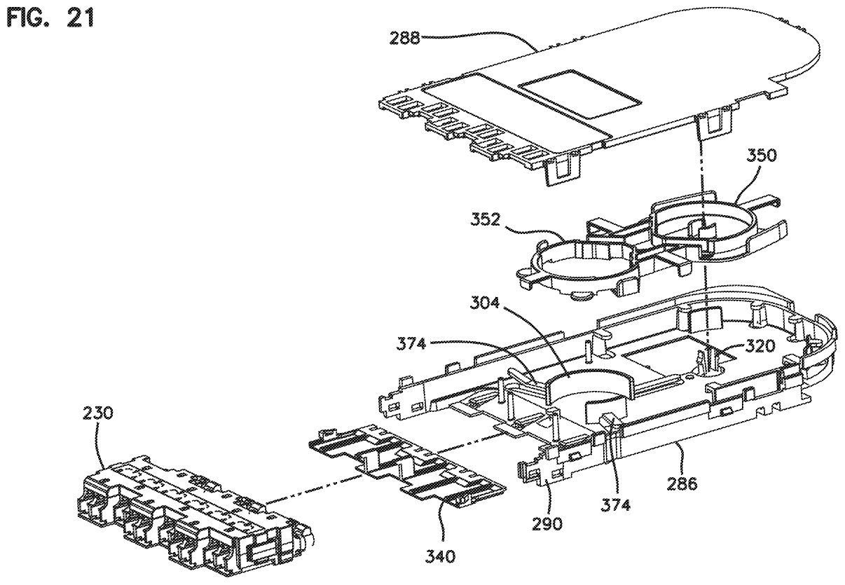

In some implementations, the port modules 200 include optical adapters. In certain examples, the port modules 200 include adapter packs, adapter modules, or cassettes that each carry or include one or more optical adapters. In other examples, the port modules 200 include electrical jacks, hybrid adapters, or other such plug receptacles. Three different types of port modules 200 are shown in FIG. 2: a multi-fiber adapter pack 210, a single-fiber adapter pack 212 and an adapter module 214. An optical cassette 216, which also is installable at the mounting stations 170 of the blade 150, is shown in FIGS. 14-23 and will be discussed in more detail herein.

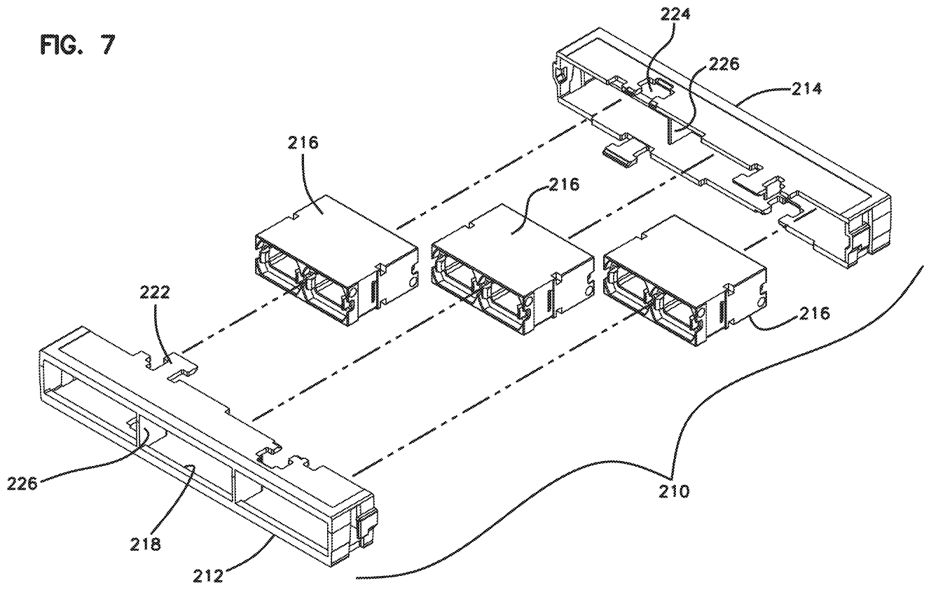

FIGS. 6-8 illustrate a first example port module 200 in the form of a multi-fiber adapter pack 210 including a first housing piece 212 that mates with a second housing piece 214 to form a combined housing 220. Mounting structures 205 are disposed at opposite sides of the combined housing 220. One or more optical adapters (e.g., MPO adapters) 216 are disposed between the first and second housing pieces 212, 214 within the combined housing 220. In some examples, the first housing piece 212 is identical to the second housing piece 214. In other examples, however, the first and second housing pieces 212, 214 can be distinct from each other.

In some implementations, the first and second housing pieces 212, 214 cooperate to define each of the mounting structures 205. In other implementations, each housing piece 212, 214 can define one of the mounting structures 205. In still other implementations, one housing piece 212, 214 can define both mounting structures 205 in full.

Each housing piece 212, 214 defines one or more apertures 218 to provide access to the ports of the adapters 216 held within the combined housing 220. In the example shown, each housing piece 212, 214 defines three apertures 218. In the example shown, each aperture 216 provides access to two ports. In other examples, however, each aperture 216 can provide access to one, three, four, six, eight, or any desired number of ports. In the example shown, each aperture 218 provides access to two multi-fiber ports. In other examples, each aperture 218 may provide access to a single port or to additional ports (e.g., three ports, four ports, six ports, twelve ports, etc.).

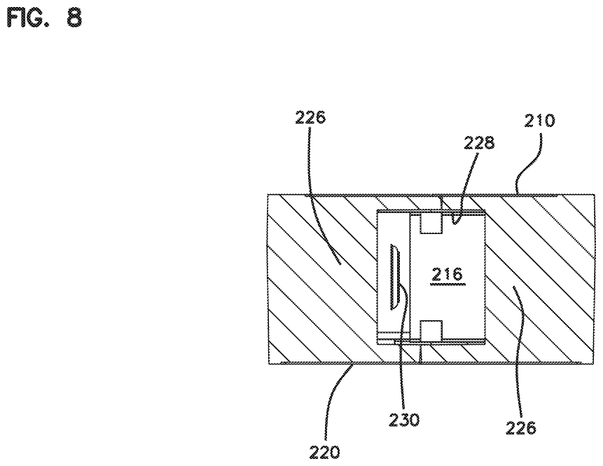

In still other examples, one or more of the apertures 218 may lead to a spacer wall extending across the aperture 218 to block access to an interior of the combined housing 220. The spacer wall is utilized in place of one or more adapter ports. In some implementations, the spacer wall is defined by a spacer structure sized and shaped similar to the adapters 216, but having solid walls instead of front and rear ports. For example, in FIG. 7, the middle adapter 216 can be replaced with a spacer structure so that front and rear ports are defined only at the outer apertures 218. Of course, the spacer structure can be placed at any aperture 218 or combination of apertures 218.

Each housing piece 212, 214 includes a retention arrangement that mates with the retention arrangement of the other housing piece 214, 212 to hold the housing pieces 212, 214 together. In the example shown, the retention arrangement of each housing piece 212, 214 includes one or more deflectable arms 222 and corresponding receiving slots 224 that receive the deflectable arms 222 of the other housing piece. In certain implementations, tape (e.g., a label) 215 can be disposed over the mated arms 222 and slots 224 to inhibit separation of the housing pieces 212, 214.

When the first and second housing pieces 212, 214 are held together, respective interior cavities of the housing pieces cooperate to define a combined interior in which one or more adapters 216 can be disposed. In the example shown, each housing piece 212, 214 includes separator walls 226 disposed between the apertures 218. In certain examples, the separator walls 226 extend at least partially between adjacent adapters 216.

In certain implementations, the separator walls 226 of the first housing piece 212 align with the separator walls 226 of the second housing piece 214 to define pockets in which the adapters 216 can be disposed. In certain examples, the separator walls 226 do not extend fully across a depth of the respective housing piece 212, 214. Rather, corresponding separator walls 226 of the first and second housing pieces 212, 214 cooperate to define a window 228 between adjacent pockets (e.g., see FIG. 8). In certain examples, one or more structural features of the adapters 216 are disposed at the window 228. For example, each adapter 216 may include a tab 230 that can be disposed at a window 228.

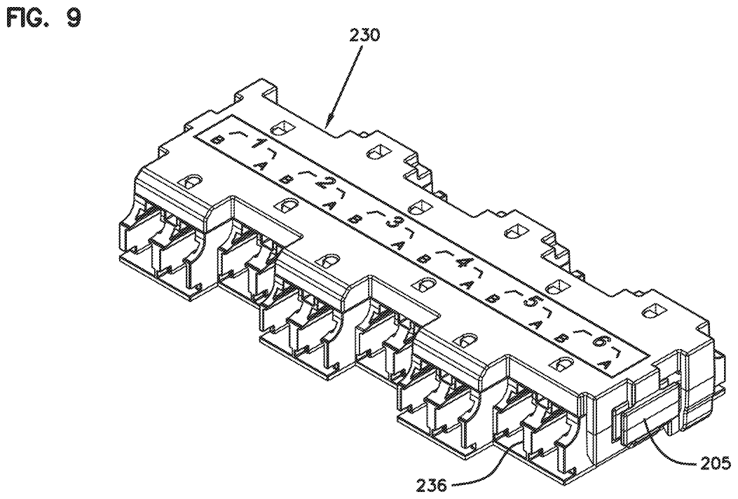

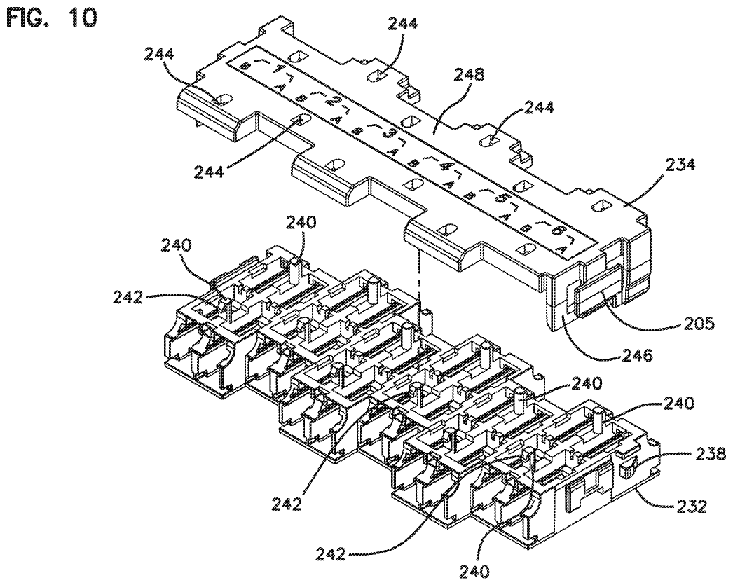

FIGS. 9-10 illustrate a second example port module 200 in the form of a single-fiber adapter pack 230 that defines a plurality of single-fiber ports. The single-fiber adapter pack 230 includes a port body 232 and a cover 234 that mounts to the port body 232. The port body 232 defines front ports 236 and rear ports that align with the front ports 236. In an example, the front and rear ports are each configured to receive an LC plug connector. In other examples, however, the front and rear ports may receive SC plug connectors or another type of single-fiber connectors. In the example shown, each adapter pack 230 defines twelve front ports. In other examples, however, each adapter pack 230 defines a greater or lesser number (e.g., one, two, four, six, eight, ten, sixteen, twenty-four, etc.) of front ports 236.

In some implementations, the port body 232 defines the mounting structures 205. In other implementations, the cover 234 defines the mounting structures 205. In the example shown, the cover 234 includes sidewalls 246 that extend downwardly from a main cover section 248. Each sidewall 246 defines one of the mounting structures 205. In certain examples, a ramped tab 238 (FIG. 10) or other retention member is disposed at each side of the port body 232 beneath the respective sidewall 246 as will be described in more detail herein.

In the example shown, the cover 234 latches to the port body 232. For example, the port body 232 may include one or more latch fingers 240 extending upwardly from the port body 232 to catches 242 at distal ends. The cover 234 defines one or more apertures 244 sized to receive the latch fingers 240 of the port body 232. In certain examples, the cover 234 defines recessed surfaces within the apertures 244. The catches 242 of the latch fingers 240 snap over the recessed surfaces to hold the cover 234 to the port body 232. In other examples, the cover 234 may otherwise secure to the port body 232 (e.g., adhesive, friction-fit, weld, fasteners, etc.).

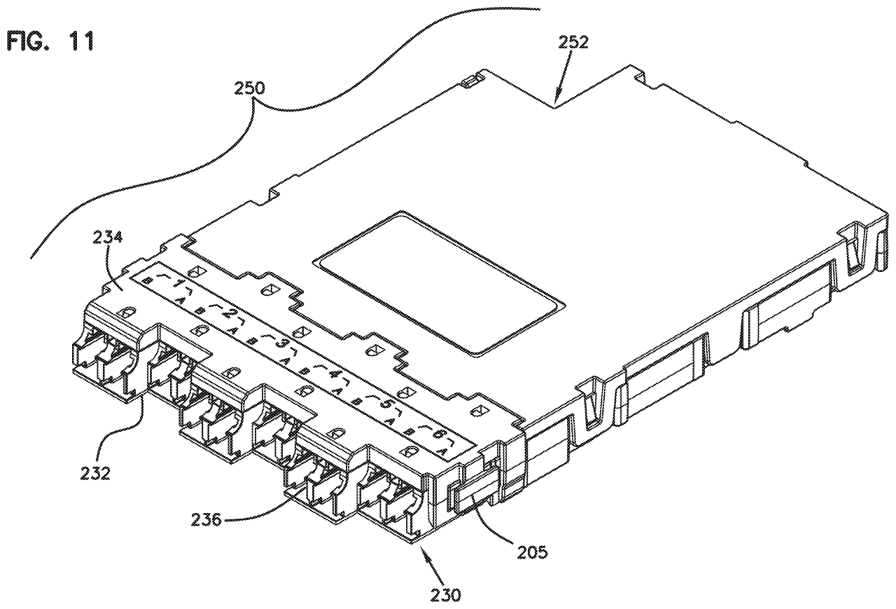

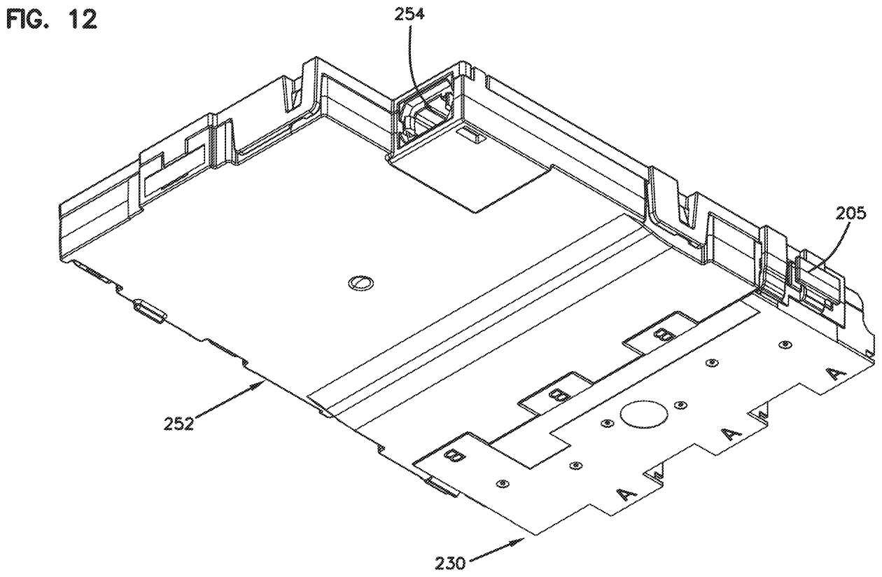

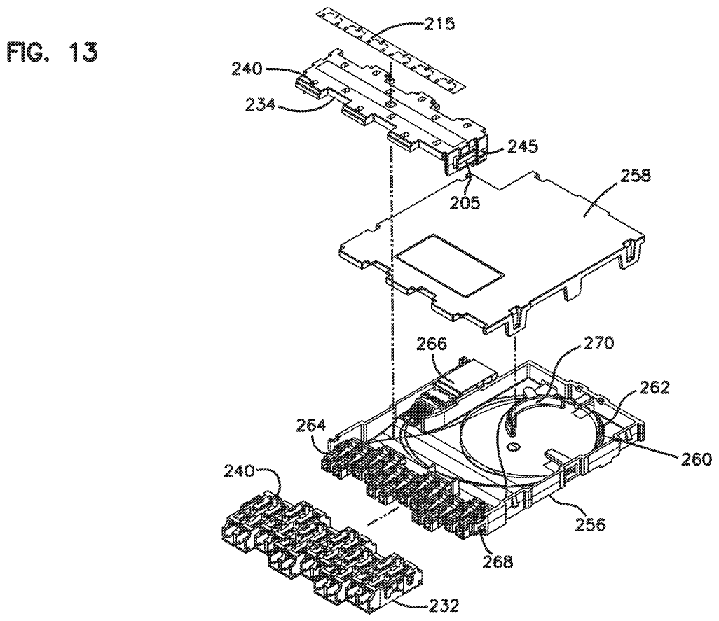

FIGS. 11-13 illustrate a third example port module 200 in the form of an adapter module 250 having multiple single-fiber ports 236 and a multi-fiber port 254. In certain implementations, the single-fiber ports 236 are front-facing ports and the multi-fiber port 254 is a rear-facing port. An optical circuit 260 optically couples the multi-fiber port 254 to the single-fiber ports 236. For example, the optical circuit 260 includes multiple optical fibers 262 having first ends separately terminated at respective single-fiber plug connectors (e.g., LC plug connectors) 264 and second ends terminated together by a multi-fiber plug connector (e.g., MPO plug connectors) 266.

In certain implementations, the module 250 includes an optical circuit protection body 252 that couples to the single-fiber adapter pack 230. The protection body 252 defines the multi-fiber port 254. The front ports 236 of the adapter pack 230 defines the single-fiber ports. The single-fiber plug connectors 264 of the optical circuit 260 are received at the rear ports of the adapter pack 230. The multi-fiber plug connector 266 of the optical circuit 260 is received at an inner port of the protection body 252 to be optically coupled to the multi-fiber port 254.

In certain implementations, the protection body 252 includes a base 256 and a corresponding cover 258 that cooperate to define an interior. In certain examples, the corresponding cover 258 latches to the base 256. In other examples, the cover 258 may be otherwise secured to the base 256 (e.g., via fasteners, welding, friction-fit, epoxy, etc.). The optical circuit 260 is disposed within the interior. Routing guides 270 are disposed within the interior to guide the optical fibers 262 between the multi-fiber port 254 and the rear ports of the adapter pack 230 without excessive bending of the fibers. The routing guides may include bend radius limiters (e.g., full or partial spools). In certain examples, the routing guides may include retention fingers to hold the optical fibers 262 within the base 256.

In certain implementations, the adapter pack 230 is non-removably coupled to the protection body 252. For example, the protection body 252 includes deflectable arms 268 that extend forwardly of the protection body 252. The deflectable arms 268 extend over opposite sides of the port body 232 of the adapter pack 230. In certain examples, the deflectable arms 268 define inner recesses that receive the ramped tabs 238 of the port body 232. The deflectable arms 268 cam over forward-facing ramp surfaces of the tabs 238 and snap over forward-facing shoulders of the tabs 238 to attach the protection body 252 to the port body 232.

When the cover 234 of the adapter pack 230 mounts to the port body 232, a retainer portion 245 of each sidewall 246 extends over one of the deflectable arms 268. The retainer portion 245 is spaced rearwardly from the mounting structure 205. Each retainer portion 245 extends over the respective deflectable arm 268 to hold the deflectable arm 268 stationary over the respective ramped tab 238. The retainer portions 245 are sufficiently stiff to inhibit outward flexing of the deflectable arms 268 away from the port body 232. Accordingly, the sidewalls 246 inhibit removal of the protection body 252 from the port body 232.

In some implementations, the adapter pack cover 234 is non-removably coupled to the port body 232. Accordingly, the sidewalls 246 cannot be removed from the deflectable arms 268 once the protection body 252 is installed at the adapter pack 230. In certain examples, the apertures 244 defined in the adapter pack cover 234 are sufficiently small to inhibit insertion of a tool to deflect the latch fingers 240 to release the cover 234. In other examples, the cover 234 can be welded, adhesively joined, riveted, or otherwise non-removably secured to the port body 232. In other implementations, the adapter pack cover 234 is removable from the port body 232 (e.g., by releasing the latch fingers 240, using fasteners, etc.).

FIGS. 14-24 illustrate a fourth example port module 200 in the form of an optical cassette 280 having multiple single-fiber ports 236 and a multi-fiber entrance 284 (e.g., a port, a sealed gland, an open passage, etc.). In certain examples, the single-fiber ports 236 are forward-facing and the multi-fiber entrance 284 is rearward facing. The optical cassette 280 holds excess length of optical fibers received at the multi-fiber entrance 284 and optically coupled to the single-fiber ports 236.

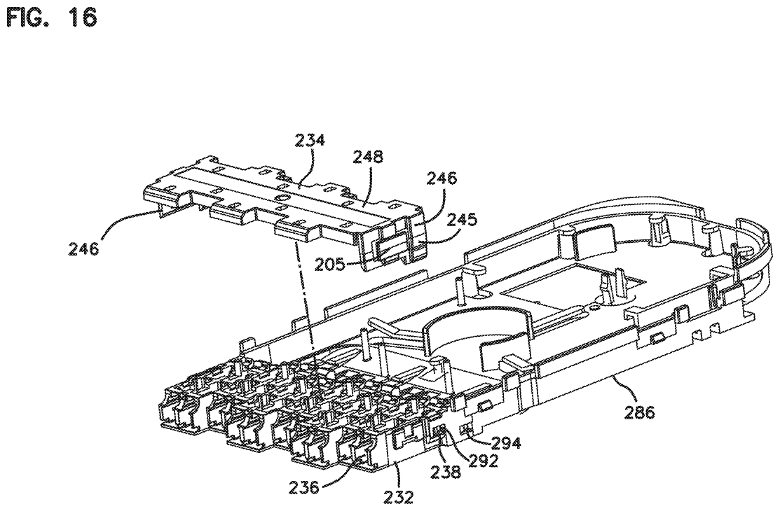

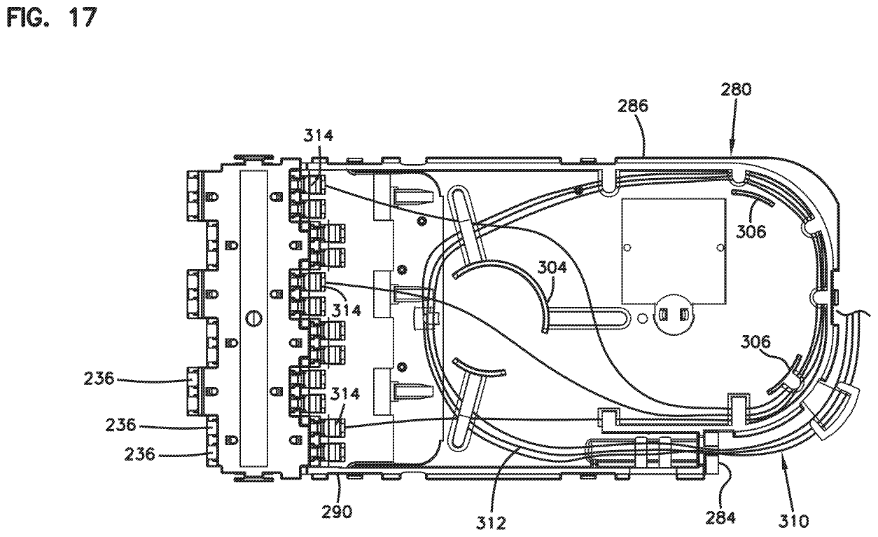

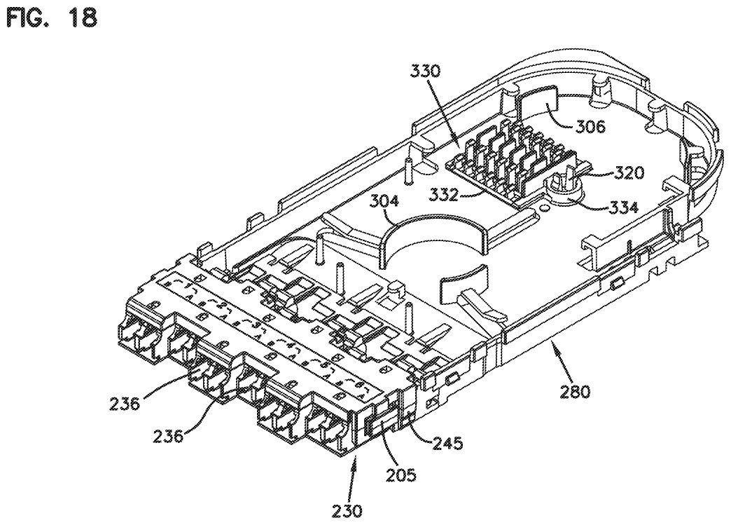

In some implementations, pre-terminated optical fibers are routed into the cassette 280, managed within the cassette 280, and optically coupled to the single-fiber ports 236 (see FIGS. 16 and 17). In other implementations, unterminated optical fibers are routed into the cassette 280 and spliced (e.g., one or more mass fusion splices or multiple single-fiber splices) to pre-terminated pigtails disposed within the cassette 280 (see FIGS. 18-23).

In certain implementations, the cassette 280 includes an optical circuit protection body 282 that couples to the single-fiber adapter pack 230. The protection body 282 defines the multi-fiber entrance 284. The front ports 236 of the adapter pack 230 defines the single-fiber ports. The protection body 282 includes a base 286 and a corresponding cover 288 that cooperates with the base to define an interior. In certain examples, the cover 288 latches to the base 286 at one or more latching arrangements 302. In the example shown, the base 286 defines ramped latch receivers and the cover 288 includes deflectable latches. In other examples, the base 286 may include the deflectable latches and the cover 288 may include the latch receivers.

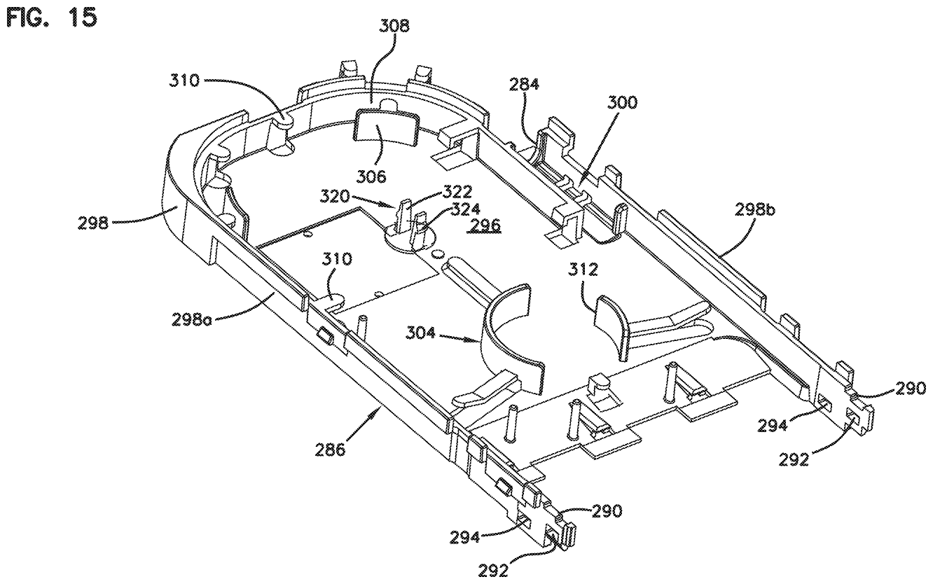

FIG. 15 shows the base 286 of the cassette protection body 282. The base 286 includes a sidewall arrangement 298 extending upwardly from a bottom surface 296. The base 286 defines an open front at which the adapter pack 230 can be coupled. The base 286 also defines an anchor region 300 at the multi-fiber entrance 284. The multi-fiber entrance 284 is configured to receive a plurality of bare fibers, a plurality of ribbon fibers, and/or a sheath containing a plurality of fibers. In certain examples, the anchor region 300 is structured to facilitate tying and/or taping of the fibers/sheath to the base 286 at the anchor region 300. For example, the anchor region 300 may define one or more apertures through which cable ties may be installed.

In certain implementations, the sidewall arrangement 298 includes a first sidewall 298A that extends along a first side and a rear of the body 282 and a second sidewall 298B that extends along a second side of the body 282 opposite the first side. In certain examples, a portion of the first sidewall 298A cooperates with the second sidewall 298B to define the anchor region 300 at the multi-fiber entrance 284.

Deflectable arms 290 extend forwardly of the open front of the base 286. In certain examples, the deflectable arms 290 are formed by the sidewall arrangement 298. Each deflectable arm 290 defines at least a first recess or aperture 292 sized to receive the ramped tab 238 of the port body 232 of the adapter pack 230. The deflectable arms 290 cam over forward-facing ramp surfaces of the tabs 238 and snap over forward-facing shoulders of the tabs 238 to attach the cassette protection body 282 to the port body 232. In certain examples, each deflectable arm 290 also defines a second recess or aperture 294 spaced rearward from the first recess or aperture 292 as will be described in more detail herein.

In certain implementations, the adapter pack 230 is non-removably coupled to the cassette protection body 282 (e.g., see FIG. 16). When the cover 234 of the adapter pack 230 mounts to the port body 232, a retainer portion 245 of each sidewall 246 extends over one of the deflectable arms 290. Each retainer portion 245 extends over the respective deflectable arm 290 to hold the deflectable arm 290 stationary over the respective ramped tab 238. The retainer portions 245 are sufficiently stiff to inhibit outward flexing of the deflectable arms 290 away from the port body 232. Accordingly, the sidewalls 246 inhibit removal of the cassette protection body 282 from the port body 232. In certain implementations, the adapter pack cover 234 is non-removably coupled to the port body 232 as described above with reference to the adapter module 250. Accordingly, the sidewalls 246 cannot be removed from the deflectable arms 290 once the protection body 282 is installed at the adapter pack 230.

Referring back to FIG. 15, the cassette protection body 282 includes guide structures disposed within the interior. The guide structures bend radius limiters forming a routing path between the multi-fiber entrance 284 and the open front where the adapter pack 230 will be installed. In certain examples, the bend radius limiters include a spool 304 towards the open front. In the example shown, the spool 304 is interrupted in that a channel 312 is defined therethrough. Another series of bend radius limiters 306 are recessed inwardly from the sidewall arrangement 298 to define a routing channel that extends around an inner periphery of the base 286 towards the rear of the base 286. Retention fingers 310 extend inwardly from the sidewall arrangement 298 and outwardly from the limiters 304, 306 to aid in maintaining the fibers within the routing path.

FIG. 17 illustrate the base 286 of the cassette 280 cabled with a pre-terminated fiber arrangement 310 in accordance with certain aspects of the disclosure. The fiber arrangement 310 includes multiple optical fibers 312 each separately terminated with a single-fiber plug connector 314. In FIG. 17, representative fibers 312 are shown disposed along the routing path between the entrance 284 and the adapter pack 230. For ease in viewing, only three of the fibers 312 are illustrated in FIG. 17.

The fibers 312 enter the base 286 at the entrance 284 and are then routed toward the open front of the base 286 to wrap around the spool 304. From the spool 304, the fibers 312 extend into the routing channel around the inner periphery of the base 286. The fibers 312 are then routed forwardly again to the adapter pack 230 at which the plug connectors 314 are plugged into the rear ports. In certain implementations, the spool 304 has an interrupted spool wall so that one or more of the fibers 312 may extend through the spool 304 to reach the rear ports of the adapter pack 230. Others of the fibers 312 may be routed to either side of the spool 304.

In the example shown, the deflectable arms 290 hold the adapter pack 230 sufficiently forward of the bottom surface 296 to accommodate finger access to the plug connectors 314. The gap between the bottom surface 296 and the adapter pack 230 also may accommodate the size of the plug connectors 314. In other examples, however, the bottom surface 296 of the base 286 may extend to the adapter pack 230.

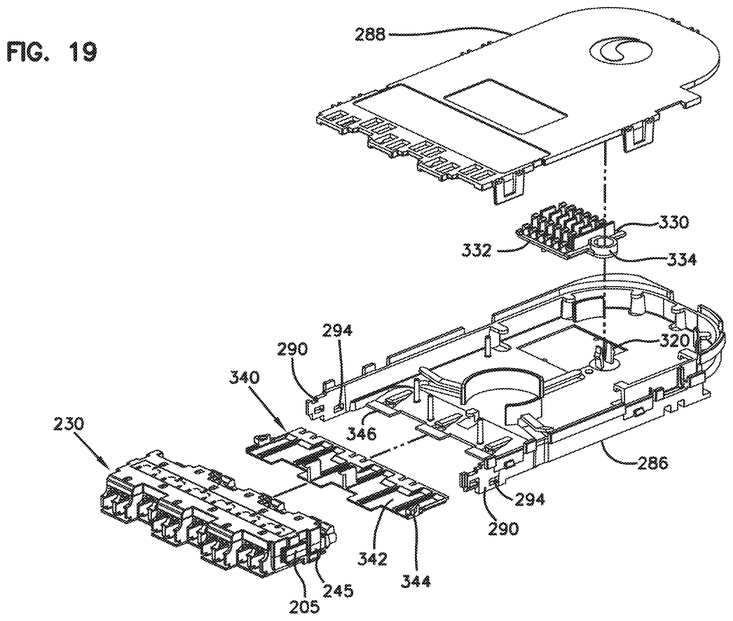

FIGS. 18 and 19 illustrate the cassette 280 loaded with a splice chip 330 configured to hold multiple single-fiber splices. The cover 288 is removed from the base 286 of the protective body 282 for ease in viewing. The base 286 includes a securement arrangement 320 to which the splice chip 330 is mounted. In some examples, the securement arrangement 320 is a latching arrangement. In the example shown, the securement arrangement 320 includes two deflectable fingers 322 (FIG. 15) extending upwardly from the bottom surface 296 of the base 286. Each finger 322 defines a catch 324 facing away from the other finger 322. The fingers 322 are deflectable towards each other.

As shown, the splice chip 330 includes a main body 332 and an attachment ring 334 that snaps over the latching arrangement 320. In certain examples, the bottom surface 296 of the base 286 defines a recess in which the splice chip 330 may seat. The recess may aid in holding the splice chip 330 in a fixed position relative to the bottom surface 296 to inhibit pulling on the optical fibers routed within the cassette 280.

As shown in FIG. 19, an insert 340 may be mounted to the base 286 to extend the bottom surface 296 forwardly to the adapter pack 230. The insert 340 may aid in retaining the fibers within the protection body 282. The insert 340 may inhibit dust or other contaminants from entering the protection body 282. The insert 340 includes a main body 342 that extends across the open end of the base 286. Ramped tabs 344 are disposed at opposite sides of the main body 342. The ramped tabs 344 fit within the rearward apertures 294 of the deflectable arms 290 of the base 286 to hold the insert 340 to the base 286. In certain examples, flat tabs 346 may extend forwardly of the bottom surface 296 of the base 286 to provide support for the main body 342 of the insert 340.

In use, pre-terminated pigtails have plug connectors plugged into the rear ports of the adapter pack 230. Opposite ends of the pigtails are routed from the rear ports, through the routing channel along part of the inner periphery of the base 286, and to a rear end of the splice chip 330. Cable fibers to be spliced to the pre-terminated pigtails extend into the cassette 280 through the entrance 284, wrap around the spool 304 at least once, and then route to the front of the splice chip 330. Excess length of the pigtails and/or the cable fibers may be taken up along the routing path around the spool 304 and the inner periphery guide channel.

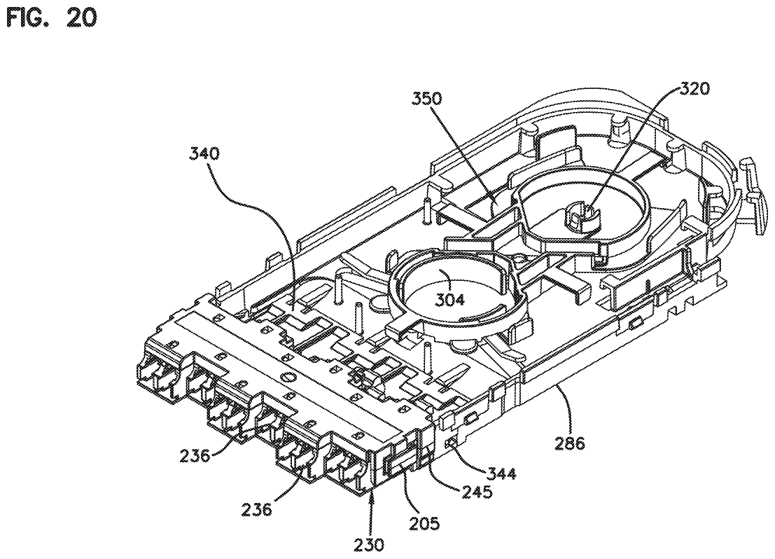

FIGS. 20-23 illustrate the cassette 280 loaded with a splice reel 350 configured to hold a mass-fusion splice between multiple pre-terminated pigtails received at the rear ports of the adapter pack 230 and multiple cable fibers received at the cassette entrance 284. The splice reel 350 also is configured to retain excess length of the pre-terminated pigtails and/or of the cable fibers. The splice reel 350 attaches to the securement arrangement 320. In certain examples, the splice reel 350 also mounts at least partially over the spool 304 as will be described in more detail herein.

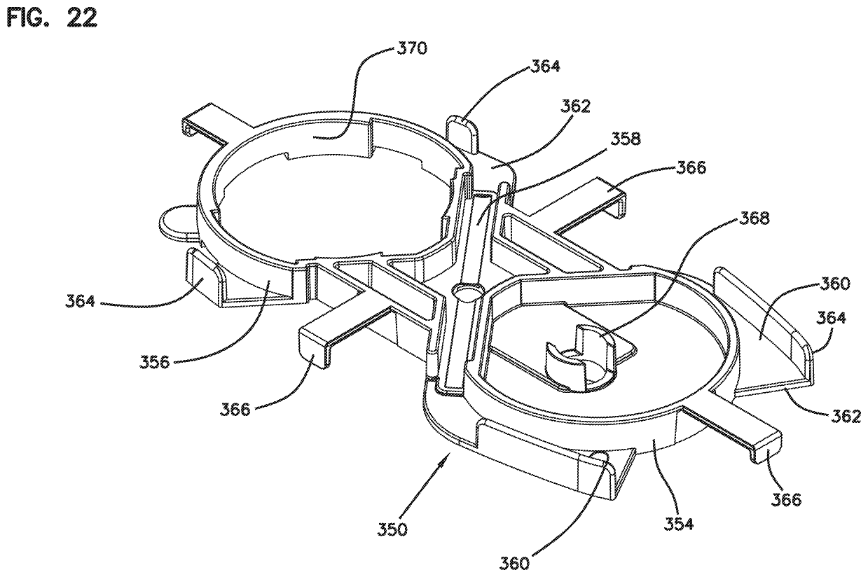

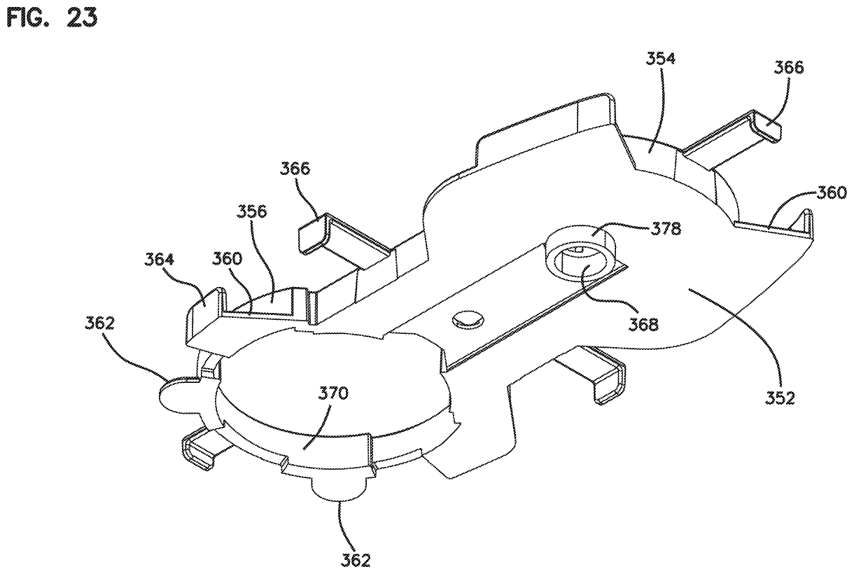

An example reel 350 is shown in FIGS. 22 and 23. The reel 350 includes a body 352 on which a first spool 354 and a second spool 356 are disposed in alignment with each other. A channel 358 configured to receive a mass fusion splice is disposed between the first and second spools 354, 356. In certain examples, the spools 354, 356 align along the forward-rearward axis X of the blade 150 when the cassette 280 is mounted to the blade 150. In such examples, the channel 358 extends at a non-transverse angle relative to the axis X.

The reel 350 also includes platforms 362 that extend outwardly from the spools 354, 356 to define outer channels 360 along which excess length of the fibers may be wound. Walls 364 may be disposed at distal ends of one or more of the platforms 362 to hold the fibers within the channels 360. Retention fingers 366 also may extend outwardly from the spools 354, 356 and/or from the body 352 of the reel 350 at locations spaced from the platforms 362. The retention fingers 366 are positioned at a raised position relative to the platforms 362.

Referring to FIG. 20, the reel 350 includes a catch arrangement 368 configured to snap over the latch arrangement 320 of the base 286. The catch feature 368 inhibits unintentional removal of the reel 350 from the base 286. In certain implementations, the second spool 356 defines an inner mounting surface 370 that fits over the spool 304 of the base 286. The engagement between the second spool 356 and the spool 304 inhibits rotation of the reel 350 relative to the base 286.

In certain implementations, the second spool 356 is suspended above the bottom surface 296 of the base 286 when mounted over the spool 304 (e.g., see FIG. 20). For example, the second spool 356 may seat on retention fingers 374 extending outwardly from the spool 304 (e.g., see FIG. 20). In certain implementations, a trunk 378 may extend downwardly from the catch arrangement 368 at the first spool 354. The trunk 374 supports the first spool 354 at a common level with the second spool 356. Accordingly, the optical cassette 280 provides two levels of fiber routing—a first level at the bottom surface 296 of the base 286 and a second level around the reel 350.

In use, pre-terminated pigtails have plug connectors plugged into the rear ports of the adapter pack 230. Opposite ends of the pigtails are spliced to respective cable fibers using a mass fusion splice. The splice is placed within the channel 358 between the first and second spools 354, 356. Excess length of the cable fibers and/or the pigtails is routed around the reel 350 (e.g., along the platform channels 360 and around the spools 354, 356). From the reel 350, the pigtail fibers and cable fibers extend into the routing path over the bottom surface 296 along the inner periphery of the base 286 and then towards the spool 304 beneath the second spool 356 of the reel 350. In certain examples, the pigtail fibers wrap around the spool 304 beneath the reel 350 before extending towards the rear ports of the adapter pack 230. The cable fibers extend from the spool 304 to the cassette entrance 284.

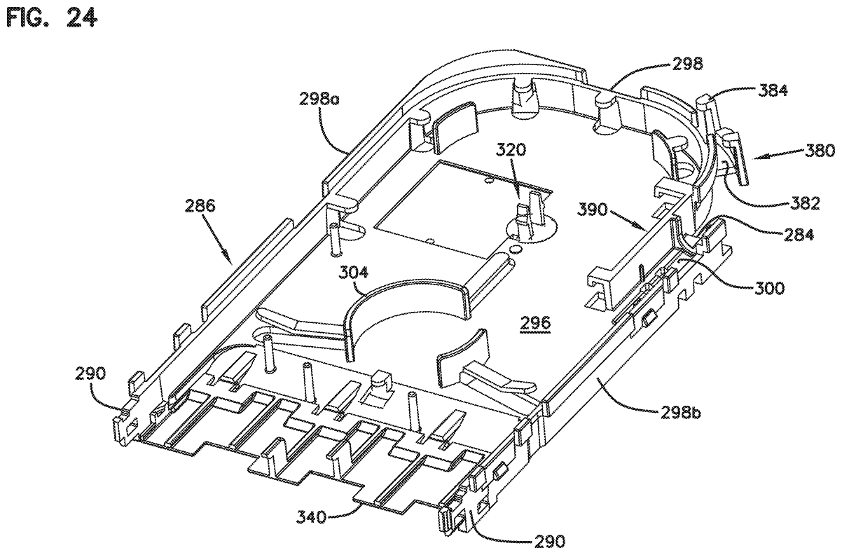

FIG. 24 illustrates another example base 286 suitable for use with the cassette 280. The base 286 includes a channel extender 380 disposed at the rear of the base 286. The channel extender 380 extends outwardly from the sidewall arrangement 298 to guide cable fibers to the fiber entrance 284. In certain examples, the channel extender 380 guides the cable fibers along a curved exterior of the protection body 282 at the rear of the protection body 282. In other examples, the base 286 may include multiple channel extenders 380 disposed at the rear of the protection body 282.

In the example shown, the channel extender 380 includes a platform 382 extending outwardly from the first sidewall 298A and two retention fingers 384 disposed at a distal end of the platform 382. In other examples, the channel extender 380 may include a greater or lesser number of retention fingers. In still other examples, a wall may replace the retention fingers 384.

In certain implementations, the base 286 may define a component station 390 sized to receive an optical power splitter, an optical wavelength splitter, or other such component. The component station 390 forms part of the routing path along the inner periphery of the base 286. In the example shown, the component station 390 laterally aligns with the anchor station 300.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A blade for use within a chassis panel, the blade comprising:
a body extending along a lateral axis between opposite first and second sides and along a forward-rearward axis between a front and a rear;
a plurality of mounting members carried by the body, each of the mounting members extending parallel to the forward-rearward axis between a first end and a second end, the mounting members being spaced from each other along the lateral axis, the first end of each mounting member defining a respective cable guide, each of the mounting members carrying a latching arrangement;
the plurality of mounting members including a first type of mounting member and a second type of mounting member, the latching arrangement of the first type of mounting member being different from the latching arrangement of the second type of mounting member.

2. The blade of claim 1, wherein the plurality of mounting members also includes a first mounting member, a second mounting member, and a third mounting member, the first and third mounting members being of the first type and the second mounting member being of the second type.

3. The blade of claim 2, further comprising an adapter block extending between opposite first and second sides, the first side being coupled to the latching arrangement of the first mounting member and the second side being coupled to the latching arrangement of the second mounting member.

4. The blade of claim 3, wherein the adapter block is a first adapter block, and wherein the blade further comprises a second adapter block extending between opposite first and second sides, the first side of the second adapter block being coupled to the latching arrangement of the second mounting member and the second side of the second adapter block being coupled to the latching arrangement of the third mounting member.

5. The blade of claim 1, wherein the latching arrangement of the first type of mounting member includes a first latch hook that deflects along the lateral axis and the latching arrangement of the second type of mounting member includes a second latch hook that deflects along the forward-rearward axis.

6. The blade of claim 1, wherein the latch hook of the latching arrangement of the first type of mounting member is a first latch hook and wherein the latching arrangement of the first type of mounting member includes second latch hook that deflects along the lateral axis, the second latch hook being laterally aligned with the first latch hook.

7. The blade of claim 1, wherein the latching arrangement of each of the mounting members of the first type includes two laterally aligned mounting locations facing in opposite directions.

8. The blade of claim 1, wherein each of the mounting members has a common length between the respective first and second ends.

9. The blade of claim 1, wherein the body includes a rear pull handle.

10. A fiber optic module comprising:
a body defining an interior, the body extending between a front and a rear, the body carrying a rearward-facing port;
an adapter pack disposed at the front of the body and defining a plurality of forward-facing ports, the adapter pack extending between opposite first and second sides and between opposite first and second ends, the adapter pack being coupled to the body so that deflectable portions of the body extend over the first and second sides;
an optical circuit disposed within the interior of the body, the optical circuit optically coupling each of the forward-facing ports to the rearward-facing port; and
a security cover mounted to the first end of the adapter pack, the security cover having overhang flanges at opposite sides of the security cover, each of the overhang flanges extending over one of the deflectable portions of the body to inhibit deflection.

11. The fiber optic module of claim 10, wherein each of the overhang flanges latches to the body.

12. The fiber optic module of claim 10, wherein the security cover is not removable from the first end of the adapter pack.

13. The fiber optic module of claim 10, further comprising a main cover mounted over the body to close the optical circuit within the interior.

14. The fiber optic module of claim 10, further comprising a fiber routing arrangement disposed within the interior of the body.

15. The fiber optic module of claim 14, wherein the fiber routing arrangement includes a bend radius limiter.

16. The fiber optic module of claim 10, wherein the rearward-facing port is recessed forwardly of the rear of the body.

17. A fiber optic cassette comprising:
a protection body extending between a front and a rear and between opposite first and second sides, the protection body including a sidewall arrangement extending upwardly from the base to define an interior of the body, the protection body defining an open front leading to the interior, the base including a snap-feature and a spool feature aligned along a front-to-rear axis, the sidewall arrangement extending forwardly beyond the base at the first and second sides of the body, the spool feature being disposed between the snap-feature and the open front, the sidewall arrangement including deflectable arms at opposite sides of the open front, the protection body also defining a routing channel extending between the interior and a rearward-facing opening at the second side of the body, the rear of the protection body being curved between the first side of the protection body and the routing channel; and
an adapter pack disposed at the open front of the protection body, the adapter pack extending between opposite first and second sides over which the deflectable arms of the sidewall arrangement snap, the adapter pack defining a plurality of rear ports disposed in a row extending between the first and second sides, the rear ports facing the interior of the protection body, the adapter pack also defining a plurality of front ports, each of the front ports aligned with one of the rear ports.

18. The fiber optic cassette of claim 17, wherein the adapter pack includes a cover having overhang flanges that extend over opposite sides of the adapter pack, each of the overhang flanges also extending over one of the deflectable arms to inhibit deflection relative to the adapter pack to secure the adapter pack to the protection body.

19. The fiber optic cassette of claim 17, wherein the spool feature includes two bend radius limiters defining a cable spool with a passage cutting therethrough.

20. The fiber optic cassette of claim 17, further comprising a channel extender disposed at the rear of the protection body, the channel extender extending outwardly from the sidewall arrangement to define an extension to the routing channel.

21. The fiber optic cassette of claim 17, further comprising a removable insert disposed at the open front of the body to extend the base, the insert extending between sections of the sidewall that extend beyond the base.

22. The fiber optic cassette of claim 21, wherein the insert is configured to slide relative to the body when installed at the body.

23. The fiber optic cassette of claim 21, wherein the insert snaps to the protection body to secure the insert to the protection body.

24. The fiber optic cassette of claim 17, further comprising a splice chip mounted within the interior of the protection body at the snap-feature, the splice chip defining a holding region for a plurality of single-fiber splices.

25. The fiber optic cassette of claim 17, further comprising a splice reel mounted within the interior of the protection body at the snap-feature, the splice reel including a holding region for a mass-fusion splice and a routing region to hold excess length of fibers being optically coupled at the mass-fusion splice.

26. The fiber optic cassette of claim 25, wherein the protection body provides a first level of fiber routing and the splice reel provides a second level of fiber routing suspended over the first level.
